(19) United States
(12) Patent Application Publication
(10) Pub. No.: US 2026/0320759 A1
(43) Pub. Date: Oct. 15, 2026

(54) METHOD AND ELECTRONIC DEVICE FOR BLUR REDUCTION OF OCCLUSION MASK FOR VIRTUAL IMAGE IN AUGMENTED REALITY GLASSES

(71) Applicant: SAMSUNG ELECTRONICS CO., LTD., Suwon-si (KR)

(72) Inventors: Ekaterina Petrovna VALIKHOVA, Moscow (RU); Ivan Alexandrovich PERMYAKOV, Moscow (RU); Nikolay Viktorovich MURAVYEV, Moscow (RU); Jaeyeol RYU, Suwon-si (KR)

(73) Assignee: SAMSUNG ELECTRONICS CO., LTD., Suwon-si (KR)

(21) Appl. No.: 19/696,723

(22) Filed: Jun. 3, 2026

Related U.S. Application Data
(63) Continuation of application No. PCT/KR2024/008699, filed on Jun. 24, 2024.

(30) Foreign Application Priority Data
Dec. 18, 2023 (RU) 2023133606

(51) Int. Cl. G06T 5/73; G06T 5/20; G06T 7/11; G06T 19/00

(52) U.S. Cl. CPC G06T 5/73; G06T 5/20; G06T 7/11; G06T 19/006

(57) ABSTRACT

An electronic device may include an electroactive panel, memory storing instructions, and one or more processors configured to execute the instructions, wherein the instructions, when executed by the one or more processors, cause the electronic device to determine a position, a size, and a shape of an occlusion mask based on a virtual image to be displayed, determine an amount of light to be blocked by the occlusion mask based on surrounding brightness, obtain an occlusion mask image representing a projection of the occlusion mask into an image space, and adjust transmittance of the electroactive panel across a plurality of zones of the electroactive panel corresponding to the occlusion mask to reduce blur in the virtual image.

### CROSS-REFERENCE TO RELATED APPLICATIONS

This application is a continuation application of International Patent Application No. PCT/KR2024/008699, filed on Jun. 24, 2024, which claims priority to Russian Patent Application No. 2023133606, filed on Dec. 18, 2023, in the Federal Service for Intellectual Property of the Russian Federation, the disclosures of which are incorporated herein by reference in their entireties.

### BACKGROUND

The present disclosure relates to augmented reality (AR) glasses, and more specifically to displaying an undistorted virtual image.

Wearable augmented reality (AR) glasses are personal devices that present video information (image) by projecting a virtual image directly into a user's eyes, thereby augmenting a real world view visible to the user. A problem in the related art problem is that, when using augmented reality glasses, the virtual image appears pale, transparent, and fuzzy when viewed against a bright real world background. To improve visibility of the virtual image against the bright real world image, occlusion masks may be used to provide a darkening background onto which the virtual image is overlaid.

Since the occlusion mask is placed close to the user's eye, the eye cannot focus, due to anatomical limitations, on the occlusion mask and the virtual image overlaid thereon. As a result, the occlusion mask may be visible beneath the virtual image with blurred edges. The blur may be eliminated by increasing the distance between the occlusion mask and the eye, doing so would increase a size of a device that forms the occlusion mask, rendering its use in augmented reality glasses impractical.

Accordingly, there may be a need for an occlusion mask display technique used in augmented reality glasses that enables a virtual image to be clearly seen and have improved contrast against a bright real world image, while reducing or eliminating of blur of the occlusion mask on which the virtual image is overlaid.

### SUMMARY

According to an embodiment of the disclosure, an electronic device for blur reduction of an occlusion mask is disclosed herein. The electronic device may include an optical system, memory configured to store instructions, and one or more processors. The instructions, when executed by the one or more processors, may cause the electronic device to determine position, size, shape and amount of light blocked by the occlusion mask, wherein the position, size and shape of the occlusion mask is determined based on position, size and shape of a virtual image. The amount of light blocked by the occlusion mask is determined based on surrounding brightness. The instructions, when executed by the one or more processors, may cause the electronic device to obtain, by the optical system, an occlusion mask image in an image space. The instructions, when executed by the one or more processors, may cause the electronic device to change transmittance of electroactive panel to reduce remaining blur by transmittance variation.

According to an embodiment of the disclosure, a method for blur reduction of an occlusion mask is disclosed herein. The method may include determining position, size, shape and amount of light blocked by the occlusion mask. The position, size and shape of the occlusion mask may be determined based on position, size and shape of a virtual image, and the amount of light blocked by the occlusion mask is determined based on surrounding brightness. The method may include obtaining, by an optical system, an occlusion mask image in an image space. The method may include changing transmittance of electroactive panel to reduce remaining blur by transmittance variation.

According to an embodiment of the disclosure, a computer-readable medium is disclosed herein. The computer-readable medium is configured to store instructions which, when executed by at least one processor of an electronic device, cause the electronic device to perform the method.

In one or more embodiments of the present disclosure, an electronic device may include: an electroactive panel; memory storing instructions; and one or more processors configured to execute the instructions; wherein the instructions, when executed by the one or more processors, cause the electronic device to: determine a position, a size, and a shape of an occlusion mask based on a virtual image to be displayed; determine an amount of light to be blocked by the occlusion mask based on surrounding brightness; obtain an occlusion mask image representing a projection of the occlusion mask into an image space; and adjust transmittance of the electroactive panel across a plurality of zones of the electroactive panel corresponding to the occlusion mask to reduce blur in the virtual image.

In one or more embodiments of the present disclosure, a method for performing image processing, may include: determining a position, a size, and a shape of an occlusion mask based on a virtual image to be displayed; determining an amount of light to be blocked by the occlusion mask based on surrounding brightness; obtaining an occlusion mask image representing a projection of the occlusion mask into an image space; and adjusting transmittance of an electroactive panel across a plurality of zones of the occlusion mask to reduce blur in the virtual image.

In one or more embodiments of the present disclosure, there is provided a computer-readable storage medium that store instructions which, when executed by at least one processor of an electronic device, cause the electronic device to perform the method of performing the image processing.

In one or more embodiments of the present disclosure, an electronic device may include: an electroactive panel configured to be positioned in front of an observer's eye and vary light transmittance; memory storing instructions; and one or more processors configured to execute the instructions to: determine a target occlusion mask based on a virtual image and ambient brightness; calculate a point spread function (PSF) based on a spatial relationship between the electroactive panel and an assumed pupil position; calculate a transmittance distribution for the electroactive panel by performing an inverse convolution of the target occlusion mask with the PSF; and drive the electroactive panel according to the transmittance distribution to produce a blur-reduced occlusion mask image in an image space at the assumed pupil position.

### BRIEF DESCRIPTION OF DRAWINGS

FIG. 1 illustrates an embodiment of a comparison of the results of using related solutions and the present invention.

FIG. 2 is a schematic view illustrating an extended occlusion mask image and the dependence of normalized distribution of light intensity on point position in image space, which defines this image.

FIG. 3 illustrates an embodiment of the extended occlusion mask area on electroactive panel.

FIG. 4 illustrates an embodiment of reduction of image nonuniformity in the central part of occlusion mask.

FIG. 5 shows a schematic structure diagram of an electronic device to which an embodiment of the present disclosure is applied.

FIG. 6A and FIG. 6B illustrates a usability and use cases of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it is to be apparent to those skilled in the art that these concepts may be practiced without these specific details. In an instance, well known structures and components are shown in block diagram form in order to avoid obscuring such concepts. In the descriptions that follow, like parts are marked throughout the specification and drawings with the same numerals, respectively.

The following description provides examples, and is not limiting of the scope, applicability, or embodiments set forth in the claims. Changes may be made in the function and/or arrangement of elements discussed without departing from the scope of the present disclosure. Various examples may omit, substitute, or add various procedures or components as appropriate. For example, the methods described may be performed in an order different from that described, and various steps may be added, omitted, and/or combined. Alternatively or additionally, features described with reference to some examples may be combined in other examples.

Various aspects and/or features may be presented in terms of systems that may include a number of devices, components, modules, and the like. It is to be understood and appreciated that the various systems may include additional devices, components, modules, and the like and/or may not include all of the devices, components, modules, and the like discussed in connection with the figures. A combination of these approaches may also be used.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

The term “module” or “component” is intended to be broadly construed as hardware, firmware, or a combination of hardware and software.

As a general introduction to the subject matter described in more detail below, aspects described herein are directed towards electronic devices, methods, systems, and computer-readable mediums for image blur reduction of an occlusion mask used for a virtual image displayed against a real world image with augmented reality glasses. The present disclosure used in augmented reality glasses enables the user to see a virtual image contrast and bright, and clearly distinguishable against the bright real world.

Terms used within the scope of this disclosure mean the following:

An electroactive panel may be a screen including elements, where each element of the electroactive panel can be either open and transmit surrounding light, or closed and do not transmit surrounding light, also each element can partially transmit surrounding light. Light transmittance of each element may be controlled by signals (e.g. from a controller) to each element. In an embodiment, the electroactive panel may include a spatial light modulator (SLM), and/or a liquid crystal display (LCD), but not limited thereto. The electroactive panel may be implemented using tunable phase gratings.

An occlusion mask may be an assembly of elements on the electroactive panel for forming an occlusion area, i.e. an area whose bounds coincide with bounds of a virtual image; moreover, the electroactive panel elements in the occlusion area can block, transmit, or partially transmit surrounding light. Virtual image may be overlaid on the occlusion mask.

Embodiments of the present disclosure provide, arranged along an optical axis:
an optical system for forming a visible image in an image space, the optical system including an image receiver, such as an eye or a camera;
an entrance pupil of the optical system;
augmented reality (AR) glasses including a screen parallel to the entrance pupil plane, where a virtual image having a specified position on the screen, a specified shape, and a specified size is disposed on the AR glasses screen;
an electroactive panel parallel to the AR glasses screen, the electroactive panel being disposed at a known distance from the plane of the optical system entrance pupil and at a known distance from the plane of the AR glasses screen on which the virtual image is located; and
a real world environment.

An electroactive panel may be secured to an AR glasses screen with an optically transparent adhesive, moreover, the AR glasses and the electroactive panel can have a common frame. An occlusion mask having the same shape as the virtual image is formed on the electroactive panel.

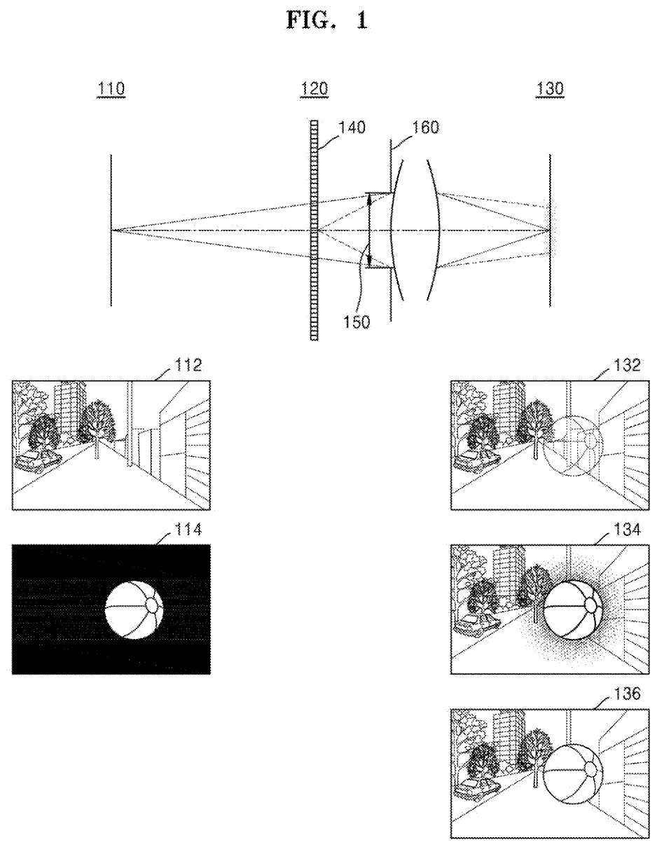

FIG. 1 illustrates an imaging system in one or more embodiments of the present disclosure.

As shown in FIG. 1, the imaging system may include an object space 110, an occlusion mask space 120, and an image space 130. The object space 110 may represent a physical environment in front of the imaging system, and may include a real-world image 112. A virtual image 114 may be superimposed onto, or combined with, the real-world image 112.

The occlusion mask space 120 may include an electroactive panel 140 and an entrance pupil 150 of an optical system 160. An occlusion mask may be formed on the electroactive panel 140, and may create a pattern of opaque and transparent areas configured to modulate or shadow light before it reaches a lens. In one or more embodiments, the electroactive panel 140 may be implemented as a spatial light modulator (SLM), such as a transmissive LCD, configured to generate a reconfigurable occlusion pattern.

The image space 130 may provide a region where light rays converge to form a projection. The image space 130 may serve as a surface where a final image is displayed or perceived, such as a digital sensor (e.g., a camera) or a human retina.

In an embodiment, the optical system 160 may be a user's eye or any other suitable optical assembly. For example, a camera may be included in the optical system 160 in assistive devices for people with photophobia.

If no occlusion mask is used to form a virtual image, the virtual image 114 may appear semi-transparent against a bright real-world image 132.

Optical performance of any optical system may be limited by optical aberrations, diffraction, and spread, so display of the occlusion mask image in the image space, including the effects of aberrations, diffraction and spread of the optical system, may be blurry. A virtual image may appear blurry, and may be surrounded by a blur area, as shown in an image 134. One or more embodiments of the present disclosure may reduce or eliminate image blur.

In one or more embodiments of the present disclosure, a method, an electronic device, a computer medium for forming an occlusion mask may provide an image 136 in which a contrast and bright image of a virtual object is formed.

In an embodiment, for computational efficiency, the position of the virtual image, and therefore the position of the occlusion mask, may be defined within an angular field area with center in the center of the entrance pupil of the optical system. Therefore, the position of a point on the electroactive panel 140 and corresponding position of the same point in the image space may be initially known.

A Point Spread Function (PSF), which describes the dependence of light distribution relative to coordinates of a point in the image plane, may be determined for each optical system. The PSF may take into account the aforementioned aberrations, diffraction, and spread of the optical system. The PSF may be determined, for example, by optical system simulation software, such as Zemax, mathematical approximation models, or empirical analysis of blurred camera images. In an embodiment, the PSF may be adjusted based on the distance of the optical system to the object perceived by the optical system. In an embodiment, the PSF may be obtained from programs for optical system design. In an embodiment, the PSF may be obtained from the blurry camera image.

In an embodiment, the entire area of the electroactive panel, and therefore the occlusion mask on the electroactive panel, may be defined by the dependence of surrounding light transmittance at each point on the position (coordinates) of the point on the electroactive panel (hereinafter referred to as transmittance dependence on the point position on the electroactive panel). Image of an electroactive panel with an occlusion mask in the image space perceived by the optical system may be defined by the dependence of normalized distribution of light intensity at each point on the position of the point in the image space (hereinafter referred to as dependence of normalized distribution of light intensity on the point position in the image space). Point positions in the image space may be easily converted to point positions on a real electroactive panel and vice versa.

The occlusion mask may be configured to correspond to the shape and position of virtual image, and its transmittance may be automatically calculated and re-adjusted each time the surrounding light changes. Therefore, the amount of light to be blocked may be known initially and depend on the surrounding light brightness (e.g. brightness level passing through the virtual image). If an occlusion mask contains only fully blocked elements on the electroactive panel, image blur of the occlusion mask may not be eliminated because there is no variation for any change in the transmittance of elements to observe the condition of constant amount of blocked light since all light is blocked. Therefore, the occlusion mask is implemented by partially darkening the electroactive panel elements.

In an embodiment, to produce an extended occlusion mask, which electroactive panel elements to be blocked according to the specified shape and size of the virtual image may be determined. Image of the extended occlusion mask may include an area corresponding to the virtual image size, and a blur area calculated with the PSF.

Predefined system parameters may include: an optical system magnification, a distance from the entrance pupil 150 of the optical system 160 to the electroactive panel 140, a focal length of the optical system 160, a diameter of the entrance pupil 150 (e.g., a human pupil diameter), and geometry (shape, size, and position) of a virtual image in the optical system field of view. Additionally, the predefined system parameters may include a target brightness (and/or an amount of light to be blocked by occlusion mask), which may vary based on surrounding brightness and ambient conditions, and a Point Spread Function (PSF) corresponding to the distance from the entrance pupil 150 to the electroactive panel 140. The predefined system parameters may be stored in the imaging system.

An image of an extended occlusion mask may be obtained as follows.

Spatial and photometric parameters (e.g., position, size, shape, and light attenuation, which indicates an amount of light blocked by the occlusion mask) of the occlusion mask may be defined based on the predefined system parameters. Size, shape and position of the occlusion mask may coincide with the size, shape and position of virtual image in the virtual image formation plane.

With the optical system magnification known, image of the occlusion mask may be formed in the image space 130. The resulting occlusion mask image in the image space 130 may be defined by the dependence of normalized distribution of light intensity on the point position in the image space 130.

The optical system PSF may be determined for the specified distance from the optical system entrance pupil (e.g., an assumed pupil position) 150 to the electroactive panel 140. Using the obtained PSF, the imaging system may calculate a blur width of the occlusion mask image. This calculation is performed by a computing system to determine how light distribution spreads across the image space 130. The blur width may be defined by the dependence of normalized distribution of light intensity on the point position in the image space 130.

In an embodiment, an image of an extended occlusion mask may be obtained by adding the blur width defined by the dependence of normalized distribution of light intensity on the point position in the image space to the occlusion mask image defined by the dependence of normalized distribution of light intensity on the point position in the image space. It should be noted that for the same PSF, the blur width may remain independent of the amount of light to be blocked.

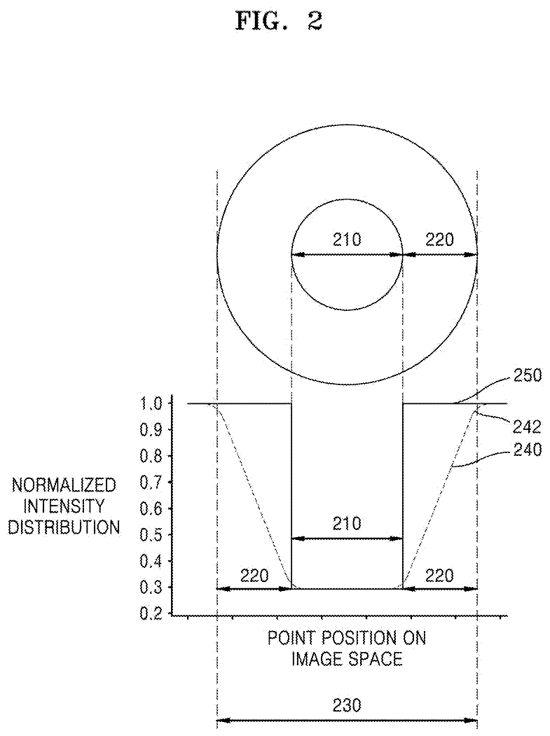

FIG. 2 is a schematic view illustrating an extended occlusion mask image, and the dependence of normalized distribution of light intensity on the point position (spatial position) in the image space, which defines the extended occlusion mask image.

In FIG. 2, an unblurred area 210 may correspond to the virtual image 114, while a blurred area 220 lies outside the bounds of the virtual image 114. FIG. 2 shows a plot of the dependence of normalized light intensity distribution on the point position in the image space, defining the extended occlusion mask image (shown by a dotted line 240) and a plot of the dependence of normalized light intensity distribution on the point position in the image space, corresponding to the occlusion mask whose size, shape, and position coincide with the size, shape, and position of the virtual image in the virtual image formation plane (shown by a solid line 250). A region 230 in the image space (FIG. 2) may correspond to the size and position of the extended occlusion mask image. Image blur may be defined or characterized by the slope of a dotted curve 242 in an area 220. To eliminate blur in the image space 130, the transmittance of elements in the extended occlusion mask area may be adjusted such that the blur is reduced, that is, the area 220 in the image space 130 is reduced. The extended occlusion mask image may be determined by bound of the virtual object.

In an embodiment, the dependence of normalized distribution of light intensity on the point position in the extended occlusion mask image may be subjected to inverse convolution with a PSF. The inverse convolution may result in the transmittance dependence on the point position in the extended occlusion mask on the electroactive panel 140, defining the extended occlusion mask area on the electroactive panel 140.

To reduce the blur effect of the occlusion mask image in the image space 130, it is proposed to divide the extended occlusion mask area on the electroactive panel 140 into multiple zones with different element transmittance values, for example, by zoning the extended occlusion mask on the electroactive panel 140. The zoning may reduce blur associated with the extended occlusion mask in the image space.

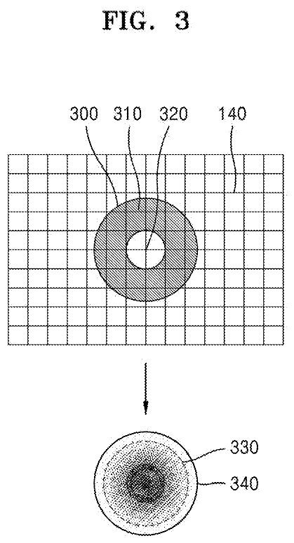

FIG. 3 illustrates an embodiment of the location of a zoned extended occlusion mask 300 on elements of the electroactive panel and a result of blur estimation. In FIG. 3, a ring is shown by way of example only, and the occlusion mask may have any shape corresponding to the shape of the virtual image. The virtual image bounds 330 may coincide with the unblurred portion 320 of the zoned extended occlusion mask 300. Reference numeral 340 may denote a blur spread region corresponding to a distribution of light intensity determined by a point spread function (PSF).

Zone 1 of the zoned extended occlusion mask 300 may be defined as a first zone 310, in which elements are blocked and do not transmit light. In an embodiment, an amount of blocked light may be equal to predetermined amount of light to be blocked based on real-world brightness. The first zone 310 may be referred as a non-transparent zone and may be determined based on the amount of blocked light.

Zone 2 of the zoned extended occlusion mask 300 may be defined as the second zone 320, located inside the first zone 310. In an embodiment, elements in the second zone 320 may transmit light. The second zone 320 may be referred as a transparent zone, and may be determined based on the size of the area needed to block light.

In an embodiment, the zoned extended occlusion mask 300 may be defined by a transmittance dependence on the point position (spatial position) in the zoned extended occlusion mask 300 on the electroactive panel. The transmittance dependence may be convoluted with PSF h(x′, y′) of the optical system used.

In an embodiment, the convolution may result in a dependence of normalized distribution of light intensity on spatial position of the zoned extended occlusion mask in the image space 130, which defines the image of the zoned extended occlusion mask. In an embodiment, the dependence of normalized distribution of light intensity on spatial position of the zoned extended occlusion mask I′(x′, y′) in the image space is expressed as Equation (1):

I′(x′,y′)=I(x,y)⊗h(x′,y′)
where I(x,y) represents the transmittance dependence on spatial position in the zoned extended occlusion mask on the electroactive panel,
x, y and x′, y′ represent coordinates of points on the electroactive panel and corresponding coordinates in the image space, respectively,
h(x′, y′) represents a PSF, ⊗ denotes a convolution operation.

The convolution operation may result in the zoned extended occlusion mask image, which will be seen by the eye, defined by I′(x′, y′).

In an embodiment, if the eye acts as an optical system, the convolution operation may result in a zoned extended occlusion mask image perceived with a residual blur area. The blur area 220 may be reduced relative to a non-zoned occlusion mask, with a remaining blur representing residual (unremoved) blur.

In an embodiment, error function E(I) may be determined between ideal occlusion mask (i.e. the dependence of normalized distribution of light intensity at each point of ideal occlusion mask on the point position in the image space, I′_{ideal}), which has no blur in the image space, and the zoned extended occlusion mask in the image space (e.g. the dependence of normalized distribution of light intensity at each point of the resulting extended zoned occlusion mask on the point position in image space I′).

In this case, error function is expressed as Equation (2):

$$E ( I ) = \sqrt{\frac{{\sum }_{t = 0}^{T} {( {I}^{′} - {I}_{ideal}^{i} )}^{2}}{T}}$$

where t∈(0,T), T is the number of electroactive panel elements.

The E(I) function may represent a difference between a calculated result and an ideal (required) result. Accordingly, a smaller value of E(I) indicates that the calculated result is closer to the ideal result.

In an embodiment, if the estimated error exceeds a predetermined threshold, the resulting zoned extended occlusion mask may be zoned again, but using a different zoning configuration. Meanwhile, edges of Zone 1 310, in which elements do not transmit light completely (blocked), may affect the residual blur of the zoned extended occlusion mask. Therefore, transmittance of the electroactive panel elements along the edge of Zone 1 310 may be adjusted on an element-by-element basis as in the steps above for each new zoned extended occlusion mask obtained after the element transmittance variation.

The steps described above may be repeated for each new zoned extended occlusion mask until the aforementioned error is less than a predetermined threshold. The zoned extended occlusion mask with the smallest error may be selected as the resulting occlusion mask. The resulting occlusion mask may be output on the electroactive panel 140 for said virtual image.

If the virtual image is overlaid on the resulting zoned extended occlusion mask 300 (hereinafter referred to as resulting occlusion mask), in some cases nonuniform distribution of light intensity may be visible, which may be eliminated. To do this, the central zone of the resulting occlusion mask 300 may be changed.

In an embodiment, blur may be minimized by changing or adjusting elements of zone 1 on an element-by-element basis. In an embodiment, by changing or varying element transmittance with attention to the virtual image bounds 330 and a blocked light level (e.g. an amount of blocked light), residual blur may be reduced. The residual blur of the zoned extended occlusion mask 300 may be determined with transmittance variation which is calculated as described above.

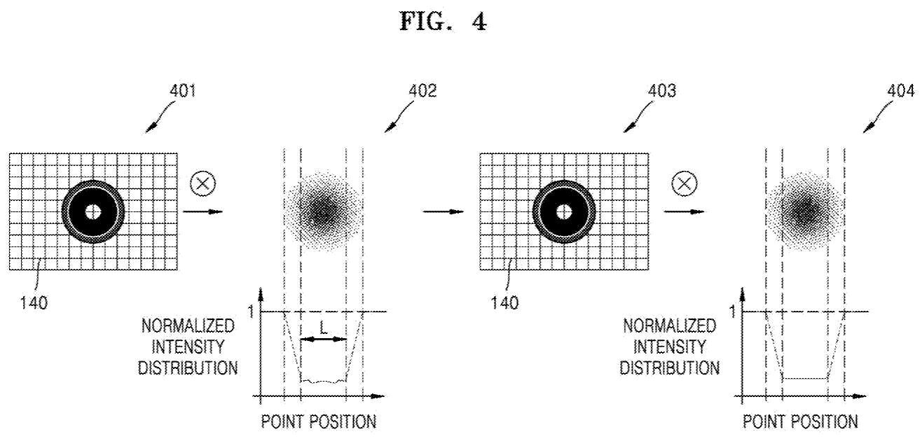

FIG. 4 illustrates how image nonuniformity in the central part of the occlusion mask is reduced. Nonuniformity in the image in the central part of the occlusion mask can be reduced after obtaining the resulting occlusion mask.

Referring to FIG. 4, in operation 401, the transmittance dependence on the point position in the resulting occlusion mask is convoluted with an PSF. In operation 402, the result is the dependence of normalized distribution of light intensity on the point position in the resulting occlusion mask image, which defines the resulting occlusion mask image. Based on the obtained image, a central area L may be determined, where image nonuniformity may be visible. In operation 402, the convolution result is provided as the image produced by the optical system in the image space and as the plot of dependence of normalized distribution of light intensity on the point position in the image plane. Peak in the central area L may determine distribution of light intensity in the nonuniformity and its position. The data may be used for zoning the image nonuniformity area in the central area L of the extended occlusion mask. In operation 403, the convolution may be performed again and the extent of nonuniformity reduction may be checked based on the error function between the ideal occlusion mask, having no image nonuniformity in the central area of the image, and the resulting occlusion mask after the latest zoning of the area with nonuniformity. In operation 404, the exhaustive search for blocking the elements on the electroactive panel 140 may be used to reduce the error below the specified threshold.

In an embodiment, a central area of the resulting occlusion mask may be rendered non-transparent or semi-transparent. Thereafter, steps similar to those used to reduce blur of the occlusion mask image may be performed, but with transmittance variation applied to the central zone of the occlusion mask. The zone transmittance may depend on a size of the virtual object and an amount of blocked light.

The number and order (e.g., arrangement) of zones in the occlusion mask, as well as an amount of light transmitted by the resulting occlusion mask may be any and may depend on a size and shape of the virtual image, and an amount of light required to be blocked, which may be predetermined and pre-stored. In an embodiment, at any zoning of the occlusion mask for the same virtual image and the same brightness, the amount of blocked light may be predetermined and pre-stored, and may remain constant regardless of a particular zoning configuration. The number and arrangement of zones in the occlusion mask may be set and adjusted based on the size of the virtual object and the amount of blocked light.

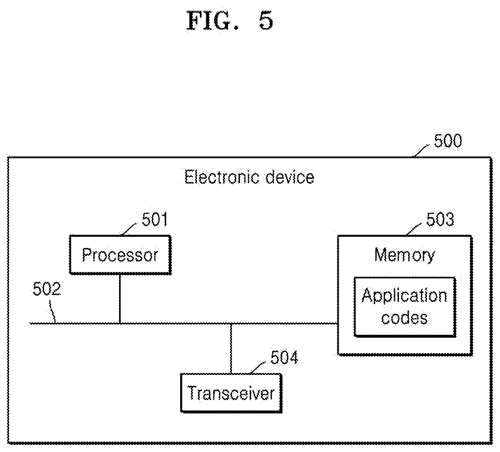

FIG. 5 shows a schematic structure diagram of an electronic in one or more embodiments of the present disclosure. As shown in FIG. 5, the electronic device 500 shown in FIG. 5 may include a processor 501 and a memory 503. The processor 501 is connected to the memory 503, for example, through a bus 502. In an example, the electronic device 500 may further include a transceiver 504, and the transceiver 504 may be used for data interaction between the electronic device 500 and other electronic devices, such as data transmission and/or data reception. It should be noted that, in practical applications, the transceiver 504 is not limited to one, and the structure of the electronic device 500 does not constitute a limitation to the embodiments of the present disclosure. In an example, the electronic device may be a first network node, a second network node or a third network node.

The processor 501 may be a central processing unit (CPU), a general-purpose processor, a digital signal processor (DSP), an application specific integrated circuit (ASIC), a field programmable gate array (FPGA) or other programmable logic devices, transistor logic devices, hardware components, or any combination thereof. It may implement or execute the various exemplary logical blocks, modules and circuits described in connection with this disclosure. The processor 501 may also be a combination that implements computing functions, such as a combination of one or more microprocessors, a combination of a DSP and a microprocessor, and the like.

The bus 502 may include a path to transfer information between the components described above. The bus 502 may be a peripheral component interconnect (PCI) bus or an extended industry standard architecture (EISA) bus or the like. The bus 502 may be divided into an address bus, a data bus, a control bus, and the like. For ease of representation, only one thick line is shown in FIG. 5, but it does not mean that there is only one bus or one type of bus.

The memory 503 may be a read only memory (ROM) or other types of static storage devices that can store static information and instructions, a random access memory (RAM) or other types of dynamic storage devices that can store information and instructions, and can also be electrically erasable programmable read only memory (EEPROM), compact disc read only memory (CD-ROM) or other optical disk storage, compact disk storage (including compressed compact disc, laser disc, compact disc, digital versatile disc, blue-ray disc, etc.), magnetic disk storage media, other magnetic storage devices, or any other medium capable of carrying or storing computer programs and capable of being read by a computer, without limitation.

The memory 503 may store computer programs for executing operations according to the embodiments of the present disclosure, and the execution is controlled by the processor 501. The processor 501 is configured to execute the computer programs stored in the memory 503 to implement the operations shown in the foregoing method embodiments.

Embodiments of the present disclosure provide a computer-readable storage medium having a computer program stored on the computer-readable storage medium, the computer program, when executed by a processor, implements the operations and corresponding contents of the foregoing method embodiments.

Embodiments of the present disclosure also provide a computer program product including a computer program, the computer program when executed by a processor realizing the operations and corresponding contents of the preceding method embodiments.

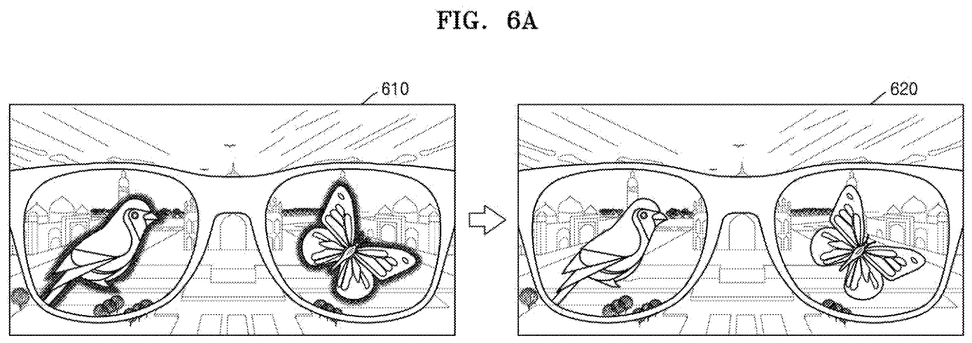

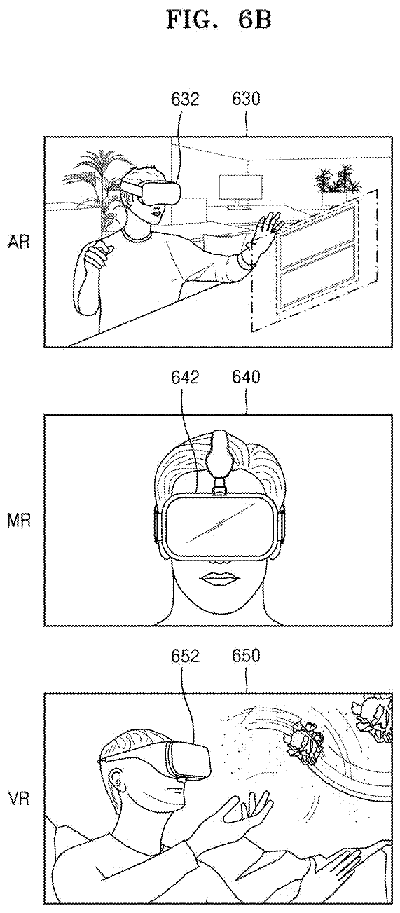

FIG. 6A and FIG. 6B illustrates a usability and use cases of the present disclosure. FIG. 6A illustrates an AR image 610 obtained using related art, and an AR image 620 obtained in using an occlusion mask according to one or more embodiments of the disclosure. In an embodiment, the proposed solution in one or more embodiments may make it possible for a user to use AR glasses in bright light conditions and see a colorful virtual image. In an embodiment, the proposed solution may make it possible for a user to see virtual image without optical occlusion blur. In an embodiment, the proposed solution may make it possible for a user to feel comfortable with portable head-mounted device. FIG. 6B illustrates use cases of one or more embodiments of the present disclosure. The one or more embodiments of the present disclosure may be used in augmented reality glasses with any brightly illuminated images of real world, including real, virtual and mixed environments (e.g., AR glasses 632, VR glasses 652, and MR glasses 642 as shown in images 630, 640, and 650), but are not limited thereto. As shown in FIG. 6A, in the AR image 620, The one or more embodiments may reduce or eliminate blur of an occlusion mask of any shape and size. The electronic device for occlusion mask blur reduction may be used with any augmented reality glasses and helmets, anywhere, including outdoors in sunny weather; owing to eliminated blur, the virtual image will not be distorted by various bright objects.

In one or more embodiments of the present disclosure, an electronic device may include: an electroactive panel; memory configured to store instructions; and one or more processors; wherein the instructions, when executed by the one or more processors, cause the electronic device to: determine a position, a size, and a shape of an occlusion mask based on a virtual image to be displayed; determine an amount of light to be blocked by the occlusion mask based on surrounding brightness; obtain an occlusion mask image representing a projection of the occlusion mask into an image space; and adjust transmittance of the electroactive panel across a plurality of zones of the occlusion mask to reduce blur in the virtual image.

The electronic device may be augmented reality (AR) glasses.

The instructions, when executed by the one or more processors, cause the electronic device to: determine a Point Spread Function (PSF) based on a spatial relationship between the electroactive panel and an assumed pupil position; and adjust the transmittance of the electroactive panel to reduce the blur by applying an inverse of the PSF to the occlusion mask.

In one or more embodiments of the present disclosure, a method for performing image processing, may include: determining a position, a size, and a shape of an occlusion mask based on a virtual image to be displayed; determining an amount of light to be blocked by the occlusion mask based on surrounding brightness; obtaining an occlusion mask image representing a projection of the occlusion mask into an image space; and adjusting transmittance of an electroactive panel across a plurality of zones of the occlusion mask to reduce blur in the virtual image.

The method may include: determining a blur width of the occlusion mask image; and obtaining an extended occlusion mask image by extending the occlusion mask image by the blur width.

The determining the blur width may include: determining a point spread function (PSF) based on a distance from an optical system entrance pupil to the electroactive panel; and determining the blur width of the occlusion mask image based on the PSF.

The obtaining the extended occlusion mask may include: performing, based on the PSF, an inverse convolution of a dependence of a normalized distribution of light intensity of a point position in the extended occlusion mask; obtaining a transmittance dependence on the point position in the extended occlusion mask on the electroactive panel; and determining a position of the extended occlusion mask on the electroactive panel.

The method may include: determining the plurality of zones of the extended occlusion mask to obtain a zoned extended occlusion mask, wherein the plurality of zones may have different transmittances of elements on the electroactive panel.

The method may include: determining the plurality of zones of the extended occlusion mask to obtain a zoned extended occlusion mask, wherein the plurality of zones have different transmittances of elements on the electroactive panel; convoluting the transmittance dependence on the point position in the zoned extended occlusion mask with the PSF; and determining a blur area of the zoned extended occlusion mask image.

The method may include: determining an error function between an ideal occlusion mask and the zoned extended occlusion mask; changing the transmittances of the elements of the electroactive panel until an error value of the error function is less than a predetermined threshold; and determining a resulting occlusion mask on the electroactive panel for the virtual image, wherein the ideal occlusion mask may have no blur in the image space.

The determining the plurality of zones of the extended occlusion mask may include: dividing an area of the electroactive panel corresponding to the virtual image into the plurality of zones such that a total light transmittance of elements of the plurality of zones is equal to the amount of light blocked by the occlusion mask.

The method may include: eliminating nonuniformity of a central area of the resulting occlusion mask.

The eliminating the nonuniformity may include: convoluting the transmittance dependence on the point position in the resulting occlusion mask with the PSF to obtain a transmittance dependence of normalized distribution of the light intensity on the point position in the resulting occlusion mask image; and determining, from the resulting occlusion mask image, a position of the nonuniformity of the central area, and a corresponding position of a nonuniformity area on the electroactive panel.

The eliminating the nonuniformity may include: determining a plurality of zones of the nonuniformity area on the electroactive panel; and determining an error function between the ideal occlusion mask and the zoned resulting occlusion mask, wherein the plurality of zones of the nonuniformity area on the electroactive panel may have difference transmittances of the elements on the electronic panel; and wherein the ideal occlusion mask may have no image nonuniformity in the central area.

The method may include: identifying the error is less than a predetermined threshold; convoluting the transmittance dependence on the point position in the resulting occlusion mask with the PSF based on a determination that the error is not less than the predetermined threshold; and obtaining the resulting occlusion mask without central area nonuniformity on the electroactive panel for the virtual image.

In one or more embodiments of the present disclosure, there is provided a computer-readable storage medium that store instructions which, when executed by at least one processor of an electronic device, cause the electronic device to perform the method of performing the image processing.

According to an embodiment of the disclosure, a device for blur reduction of an occlusion mask used for a virtual image displayed against a real world image with augmented reality (AR) glasses is disclosed herein. The device may include, arranged along an optical axis, an optical system for producing a visible image in image space. The device may include AR glasses with a screen parallel to an entrance pupil plane, wherein a virtual image located on the AR glasses screen has a specified position on the screen, a specified shape, and a specified size. The device may include an electroactive panel parallel to the AR glasses screen, the electroactive panel being placed at a known distance from the plane of the optical system entrance pupil and at a known distance from the plane of the AR glasses screen, where the virtual image is located. The device may capture and display a real world image. The electroactive panel may be a display screen consisting of elements. Each electroactive panel element may be either open, where the element transmits surrounding light, or closed, where the element does not transmit surrounding light, or can partially transmit surrounding light. The light transmittance of each element may be controlled by signals to each element. The electroactive panel may be configured to form a resulting occlusion mask for forming an occlusion area in the virtual image space by changing the light transmittance of said elements. Bounds of the occlusion area may coincide with bounds of the virtual image. The transmittance of the electroactive panel elements of the resulting occlusion mask in the occlusion area may be such that the error function between an ideal occlusion mask, which has no blur in the image space, and said resulting occlusion mask is less than a predetermined threshold.

The optical system may be user's eye. The optical system may be a camera.

According to an embodiment of the disclosure, a method for operating a device for blur reduction of an occlusion mask used for a virtual image displayed against a real world image with augmented reality (AR) glasses is disclosed herein

In one or more embodiments of the present disclosure, an electronic device may include: an electroactive panel configured to be positioned in front of an observer's eye and vary light transmittance; memory storing instructions; and one or more processors configured to execute the instructions to: determine a target occlusion mask based on a virtual image and ambient brightness; calculate a point spread function (PSF) based on a spatial relationship between the electroactive panel and an assumed pupil position; calculate a transmittance distribution for the electroactive panel by performing an inverse convolution of the target occlusion mask with the PSF; and drive the electroactive panel according to the transmittance distribution to produce a blur-reduced occlusion mask image in an image space at the assumed pupil position.

The one or more processors may be further configured to: determine a blur width based on the PSF; and generate an extended occlusion mask by adding the determined blur width to boundaries of the target occlusion mask before performing the inverse convolution.

The one or more processors may be further configured to: divide an area of the electroactive panel into a plurality of zones; and assign different transmittance levels to each of the plurality of zones to approximate the transmittance distribution, such that a total light transmittance of the zones corresponds to a target amount of light blocked by the occlusion mask.

The one or more processors may be further configured to: calculate an error function by comparing the blur-reduced occlusion mask image against an ideal occlusion mask having no blur; and iteratively adjust the transmittance of individual elements of the electroactive panel until the error function is less than a predetermined threshold.

The foregoing embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An electronic device comprising:
an electroactive panel;
memory storing instructions; and
one or more processors configured to execute the instructions;
wherein the instructions, when executed by the one or more processors, cause the electronic device to:
determine a position, a size, and a shape of an occlusion mask based on a virtual image to be displayed;
determine an amount of light to be blocked by the occlusion mask based on surrounding brightness;
obtain an occlusion mask image representing a projection of the occlusion mask into an image space; and
adjust transmittance of the electroactive panel across a plurality of zones of the electroactive panel corresponding to the occlusion mask to reduce blur in the virtual image.

2. The electronic device according to claim 1, wherein the electronic device is augmented reality (AR) glasses.

3. The electronic device according to claim 1, wherein the instructions, when executed by the one or more processors, cause the electronic device to:
determine a Point Spread Function (PSF) based on a spatial relationship between the electroactive panel and an assumed pupil position; and
adjust the transmittance of the electroactive panel to reduce the blur by performing an inverse convolution of the occlusion mask image with the PSF.

4. A method for performing image processing, the method comprising:
determining a position, a size, and a shape of an occlusion mask based on a virtual image to be displayed;
determining an amount of light to be blocked by the occlusion mask based on surrounding brightness;
obtaining an occlusion mask image representing a projection of the occlusion mask into an image space; and
adjusting transmittance of an electroactive panel across a plurality of zones of the occlusion mask to reduce blur in the virtual image.

5. The method according to claim 4, further comprising:
determining a blur width of the occlusion mask image; and
obtaining an extended occlusion mask image by extending the occlusion mask image by the blur width.

6. The method according to claim 5, wherein the determining the blur width comprises:
determining a point spread function (PSF) based on a distance from an optical system entrance pupil to the electroactive panel; and
determining the blur width of the occlusion mask image based on the PSF.

7. The method according to claim 6, wherein the obtaining the extended occlusion mask comprises:
performing, based on the PSF, an inverse convolution of a dependence of a normalized distribution of light intensity of a point position in the extended occlusion mask;
obtaining a transmittance dependence on the point position in the extended occlusion mask on the electroactive panel; and
determining a position of the extended occlusion mask on the electroactive panel.

8. The method according to claim 4, further comprising:
determining the plurality of zones of the extended occlusion mask to obtain a zoned extended occlusion mask,
wherein the plurality of zones have different transmittances of elements on the electroactive panel.

9. The method according to claim 7, further comprising:
determining the plurality of zones of the extended occlusion mask to obtain a zoned extended occlusion mask, wherein the plurality of zones have different transmittances of elements on the electroactive panel;
convoluting the transmittance dependence on the point position in the zoned extended occlusion mask with the PSF; and
determining a blur area of the zoned extended occlusion mask image.

10. The method according to claim 9, further comprising:
determining an error function between an ideal occlusion mask and the zoned extended occlusion mask;
changing the transmittances of the elements of the electroactive panel until an error value of the error function is less than a predetermined threshold; and
determining a resulting occlusion mask on the electroactive panel for the virtual image,
wherein the ideal occlusion mask has no blur in the image space.

11. The method according to claim 4, wherein the determining the plurality of zones of the extended occlusion mask comprises:
dividing an area of the electroactive panel corresponding to the virtual image into the plurality of zones such that a total light transmittance of elements of the plurality of zones is equal to the amount of light blocked by the occlusion mask.

12. The method according to claim 10, further comprising:
eliminating nonuniformity of a central area of the resulting occlusion mask.

13. The method according to claim 12, wherein the eliminating the nonuniformity comprises:
convoluting the transmittance dependence on the point position in the resulting occlusion mask with the PSF to obtain a transmittance dependence of normalized distribution of the light intensity on the point position in the resulting occlusion mask image; and
determining, from the resulting occlusion mask image, a position of the nonuniformity of the central area, and a corresponding position of a nonuniformity area on the electroactive panel.

14. The method according to claim 13, wherein the eliminating the nonuniformity comprises:
determining a plurality of zones of the nonuniformity area on the electroactive panel; and
determining an error function between the ideal occlusion mask and the zoned resulting occlusion mask,
wherein the plurality of zones of the nonuniformity area on the electroactive panel have different transmittances of the elements on the electronic panel, and
wherein the ideal occlusion mask has no image nonuniformity in the central area.

15. The method according to claim 4, further comprising:
identifying whether the error is less than a predetermined threshold;
convoluting the transmittance dependence on the point position in the resulting occlusion mask with the PSF based on a determination that the error is not less than the predetermined threshold; and
obtaining the resulting occlusion mask without central area nonuniformity on the electroactive panel for the virtual image.

16. A computer-readable storage medium that stores instructions which, when executed by at least one processor of an electronic device, cause the electronic device to perform the method of claim 4.

17. The electronic device according to claim 1,
wherein the instructions, when executed by the one or more processors, cause the electronic device to:
determine a point spread function (PSF) based on a spatial relationship between the electroactive panel and an assumed pupil position; and
calculate a transmittance distribution for the electroactive panel by performing an inverse convolution of the occlusion mask image with the PSF; and
drive the electroactive panel according to the transmittance distribution to produce a blur-reduced occlusion mask image in an image space at the assumed pupil position.

18. The electronic device according to claim 17, wherein the one or more processors are further configured to:
determine a blur width based on the PSF; and
generate an extended occlusion mask by adding the determined blur width to boundaries of the occlusion mask image before performing the inverse convolution.

19. The electronic device according to claim 1, wherein the one or more processors are further configured to:
divide an area of the electroactive panel into a plurality of zones; and
assign different transmittance levels to each of the plurality of zones to approximate the transmittance distribution, such that a total light transmittance of the zones corresponds to a target amount of light blocked by the occlusion mask.

20. The electronic device according to claim 1, wherein the one or more processors are further configured to:
calculate an error function by comparing the blur-reduced occlusion mask image against an ideal occlusion mask having no blur; and
iteratively adjust the transmittance of individual elements of the electroactive panel until the error function is less than a predetermined threshold.
